(19) United States
(12) Patent Application Publication
(10) Pub. No.: US 2010/0012679 A1
(43) Pub. Date: Jan. 21, 2010

(54) Dispensers For Dispensing a Flowable Product and Methods For Controlling the Dispensers

(75) Inventor: Warren R. Brownlee, Palmetto, GA (US)

Correspondence Address: Georgia-Pacific LLC, 133 Peachtree Street NE - GA030-41, ATLANTA, GA, 30303, US

(73) Assignee: GEORGIA-PACIFIC CONSUMER PRODUCTS LP, Atlanta, GA (US)

(21) Appl. No.: 12/173,287

(22) Filed: Jul. 15, 2008

(51) Int. Cl. B67D 1/00; G05D 7/00

(52) U.S. Cl. 222/52; 222/333; 700/282

(57) ABSTRACT

Dispensers for dispensing a flowable product and methods for controlling the dispensers are provided. In one exemplary embodiment, a dispenser has a sensor, a container holding the flowable product therein, a pumping unit fluidly communicating with the container, an ultraviolet light source, and a controller. A method includes generating a first signal utilizing the sensor of the dispenser. The method further includes generating a second signal to induce the ultraviolet light source of the dispenser to emit ultraviolet light in response to the controller of the dispenser receiving the first signal from the sensor.

### BACKGROUND OF THE INVENTION

Soap dispensers have been developed that dispense soap. After a soap dispenser dispenses soap on a person's hands, the person typically applies water to the soap and washes their hands with the soap and water to kill bacteria on the hands. Although the soap and water generally kill a portion of the bacteria on the person's hands, some bacteria may undesirably remain on the hands.

Accordingly, the inventor herein has recognized a need for a dispenser for dispensing a flowable product that minimizes and/or eliminates the above-mentioned deficiency.

### BRIEF DESCRIPTION OF THE INVENTION

A dispenser for dispensing a flowable product in accordance with an exemplary embodiment is provided. The dispenser includes a housing and a container disposed in the housing. The container holds the flowable product therein. The dispenser further includes a pumping unit disposed in the housing. The pumping unit fluidly communicates with the container. The pumping unit is configured to pump the flowable product from the container. The pumping unit further includes an ultraviolet light source disposed on the housing. The ultraviolet light source is configured to emit ultraviolet light.

A method for controlling a dispenser for dispensing a flowable product in accordance with another exemplary embodiment is provided. The dispenser has a sensor, a container holding the flowable product therein, a pumping unit fluidly communicating with the container, an ultraviolet light source, and a controller. The method includes generating a first signal utilizing the sensor of the dispenser. The method further includes generating a second signal to induce the ultraviolet light source of the dispenser to emit ultraviolet light in response to the controller of the dispenser receiving the first signal from the sensor.

### BRIEF DESCRIPTION OF THE DRAWINGS

FIG. 1 is a schematic of an automatic dispenser for dispensing a flowable product in accordance with an exemplary embodiment;

FIG. 2 is a cross-sectional schematic of the automatic dispenser of FIG. 1;

FIG. 3 is a block diagram of portions of the automatic dispenser of FIG. 1;

FIG. 4 is a flowchart of a method for controlling the automatic dispenser of FIG. 1 for dispensing the flowable product in accordance with another exemplary embodiment;

FIG. 5 is a schematic of a manual dispenser for dispensing a flowable product in accordance with another exemplary embodiment;

FIG. 6 is a cross-sectional schematic of the manual dispenser of FIG. 5;

FIG. 7 is a schematic of a pumping unit utilized in the manual dispenser of FIG. 5;

FIG. 8 is a block diagram of portions of the manual dispenser of FIG. 5; and

FIG. 9 is a flowchart of a method for controlling the manual dispenser of FIG. 5 for dispensing the flowable product in accordance with another exemplary embodiment.

### DETAILED DESCRIPTION OF THE INVENTION

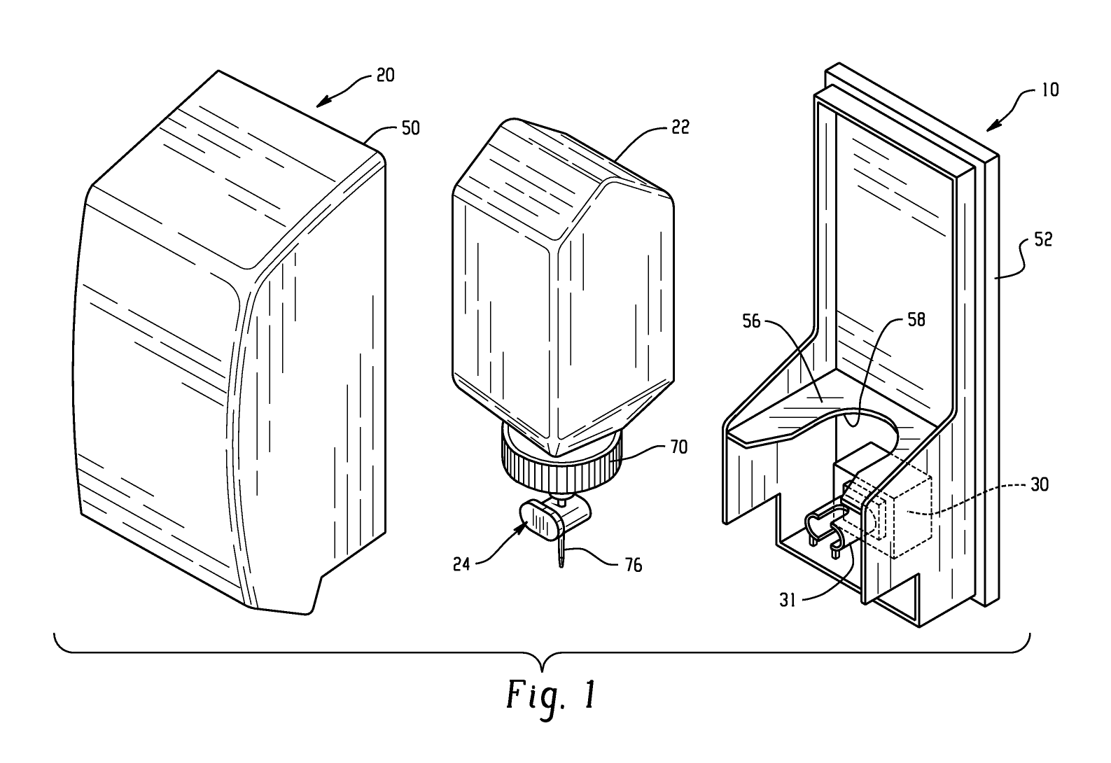

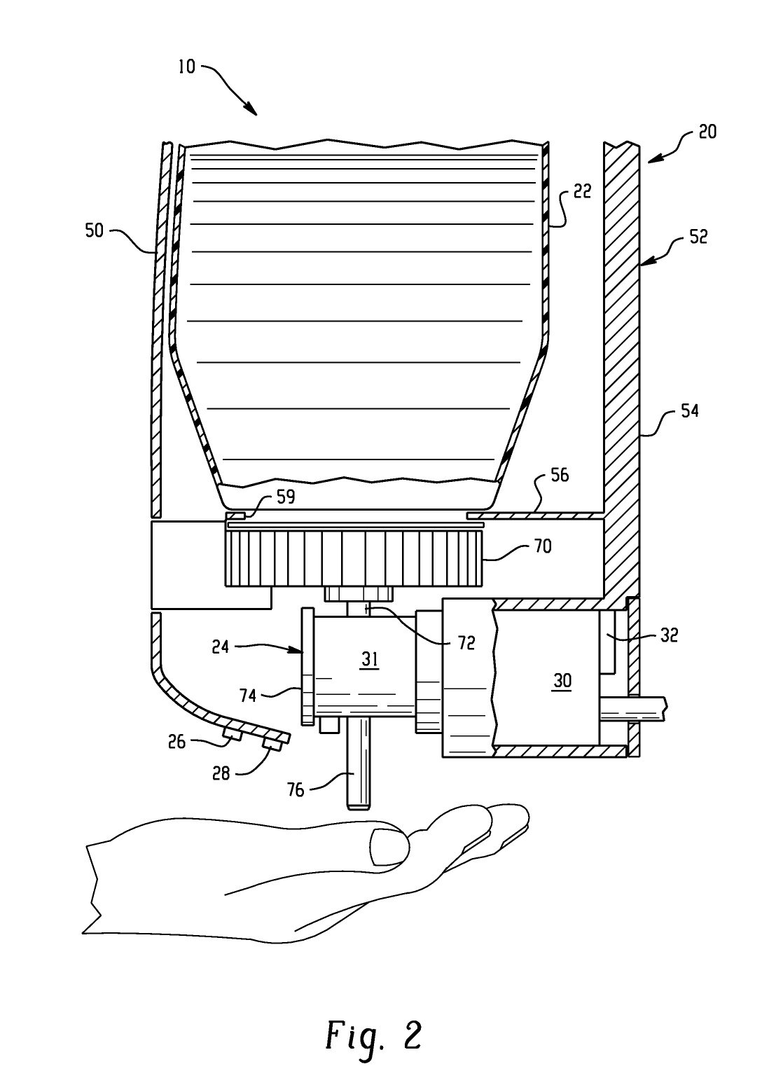

Referring to FIGS. 1 and 2, an automatic dispenser 10 for dispensing a flowable product is illustrated. The automatic dispenser 10 includes a housing 20, a container 22, a pumping unit 24, a proximity sensor 26, an ultraviolet light source 28, a motor 30, a socket 31, and a controller 32. The flowable product comprises any product that can be pumped out of a dispenser. For example, the flowable product can comprise at least one of: (i) a soap, (ii) an antibacterial substance or lotion, (iii) a powder, (iv) a liquid, (v) a foam, (vi) a gel, (vii) a lotion and (viii) a detergent. An advantage of the automatic dispenser 10 is that the automatic dispenser 10 can emit an ultraviolet light to kill bacteria on a person's hands in addition to dispensing the flowable product.

The housing 20 is provided to enclose a portion of the remaining components of the automatic dispenser 10. The housing 20 includes a front cover 50 and a back cover 52. In one exemplary embodiment, the front cover 50 and the back cover 52 are constructed from plastic. The front cover 50 is configured to be attached to the back cover 52. The back cover 52 is configured to be mounted on a wall (not shown). The back cover 52 includes a back plate 54 and a wall 56. The wall 56 extends substantially perpendicular to the back plate 54. The wall 56 further includes an arcuate-shaped notch 58 for receiving a portion of the container 22 therein. The wall 56 holds the container 22 thereon.

The container 22 is provided to hold the flowable product therein. The container 22 can be constructed from plastic. The container 22 includes an opening 59 for allowing the flowable product to be pumped from the container 22.

The pumping unit 24 is provided to pump the flowable product from the container 22. The pumping unit 24 includes a cap 70, a feed tube 72, a pump 74, and an exit tube 76. The cap 70 is coupled to the container 22 proximate to the opening 59 and to the feed tube 72. The feed tube 72 is fluidly coupled to the pump 74. The pump 74 is further fluidly coupled to the exit tube 76. The pumping unit 24 is disposed within the socket 31 of the automatic dispenser 10. The pumping unit 24 is further operably coupled to the motor 30 which is configured to drive the pumping unit 24 to pump flowable product from the container 22 through the feed tube 72 and the pump 74 to the exit tube 76. The flowable product flows from the exit tube 76 onto a person's hands.

The proximity sensor 26 is configured to generate a signal when an object is disposed proximate to the proximity sensor 26. In particular, the proximity sensor 26 generates the signal when a person's hands are disposed proximate to the housing 20 to receive the flowable product thereon. The signal from the proximity sensor 26 is received by the controller 32. In one exemplary embodiment, the proximity sensor 26 is disposed on an external portion of the housing 20 proximate to the exit tube 76.

The ultraviolet light source 28 is configured to emit ultraviolet light in response to signal received from the controller 32. In one exemplary embodiment, the ultraviolet light source 28 is disposed on an external portion of the housing 20 proximate to the exit tube 76. Further, in one exemplary embodiment, the ultraviolet light is in either the B-band (i.e., 320 nm-280 nm wavelength with energy per photon of 3.10-3.87 eV) or C-band (i.e., below 280 nm wavelength with energy per photon of 4.43-6.20 eV) of an ultraviolet light spectrum. In another exemplary embodiment, the ultraviolet light has a wavelength of 253.7 nm with a radiation level of 3.0 Joules/m².

The motor 30 is operably coupled to the pumping unit 24. The motor 30 is configured to actuate the pumping unit 24 to pump flowable product from the container 22 in response to a signal from the controller 32. The motor 30 is coupled to the back cover 52 of the housing 20.

The socket 31 is disposed on the motor 30 and is configured to receive the pump 74 therein. In one exemplary embodiment, the socket 31 is constructed from plastic.

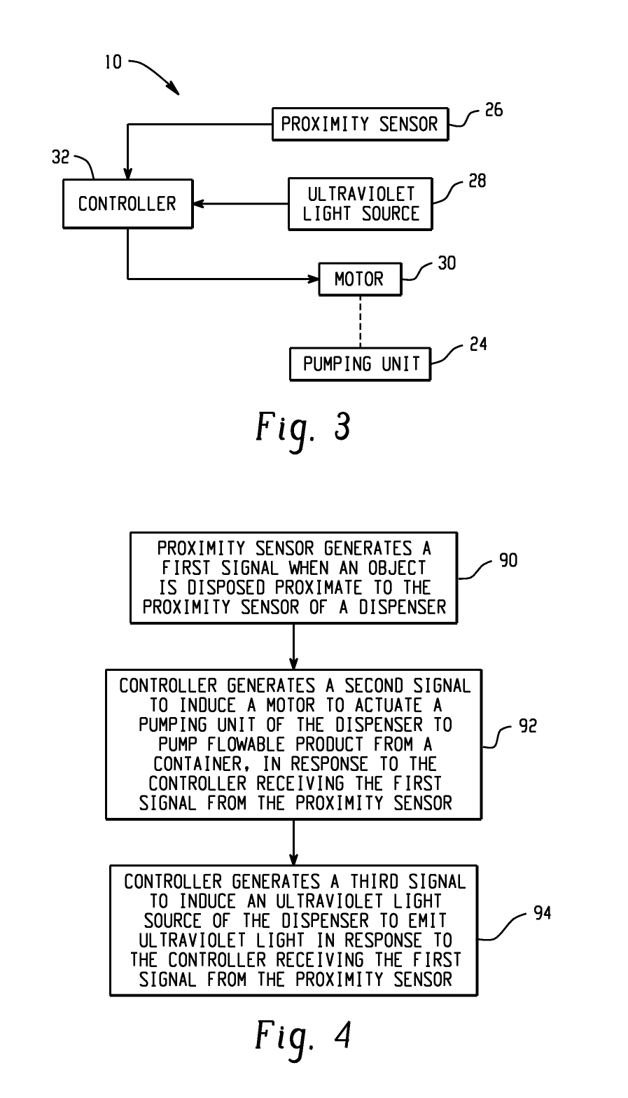

Referring to FIG. 3, the controller 32 is provided to control operation of the automatic dispenser 10. The controller 32 is electrically coupled to the proximity sensor 26, the ultraviolet light source 28, and the motor 30. The controller 32 is configured to receive a signal from the proximity sensor 26 indicating an object, such as a person's hands, are disposed proximate to the housing 20 (FIG. 1). The controller 32 is further configured to generate another signal to induce the ultraviolet light source 28 to emit ultraviolet light onto a person's hands to kill bacteria thereon. The controller 32 is further configured to generate another signal to actuate the motor 30 to actuate the pumping unit 24.

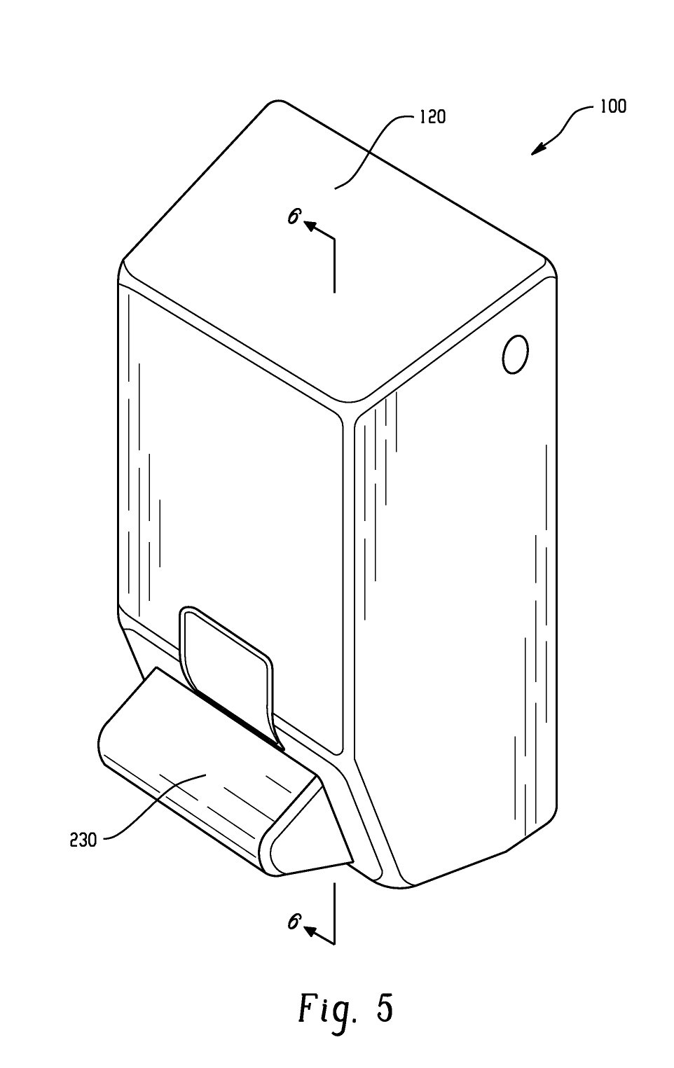

Referring to FIG. 4 (with periodic reference to FIGS. 1 and 2), a flowchart of a method for controlling of the automatic dispenser 10 in accordance with another exemplary embodiment will now be explained.

At block 90, the proximity sensor 26 generates a first signal when an object is disposed proximate to the proximity sensor 26 of the automatic dispenser 10.

At block 92, the controller 32 generates a second signal to induce the motor 30 to actuate the pumping unit 24 of the automatic dispenser 10 to pump flowable product from the container 22, in response to the controller 32 receiving the first signal from the proximity sensor 26.

At block 94, the controller 32 generates a third signal to induce the ultraviolet light source 28 of the automatic dispenser 10 to emit ultraviolet light in response to the controller 32 receiving the first signal from the proximity sensor 26. In an alternative embodiment, the controller 32 waits a predetermined time interval after generating the second signal to generate the third signal, thereby inducing the ultraviolet light source 28 to emit ultraviolet light after initiating pumping of the flowable product.

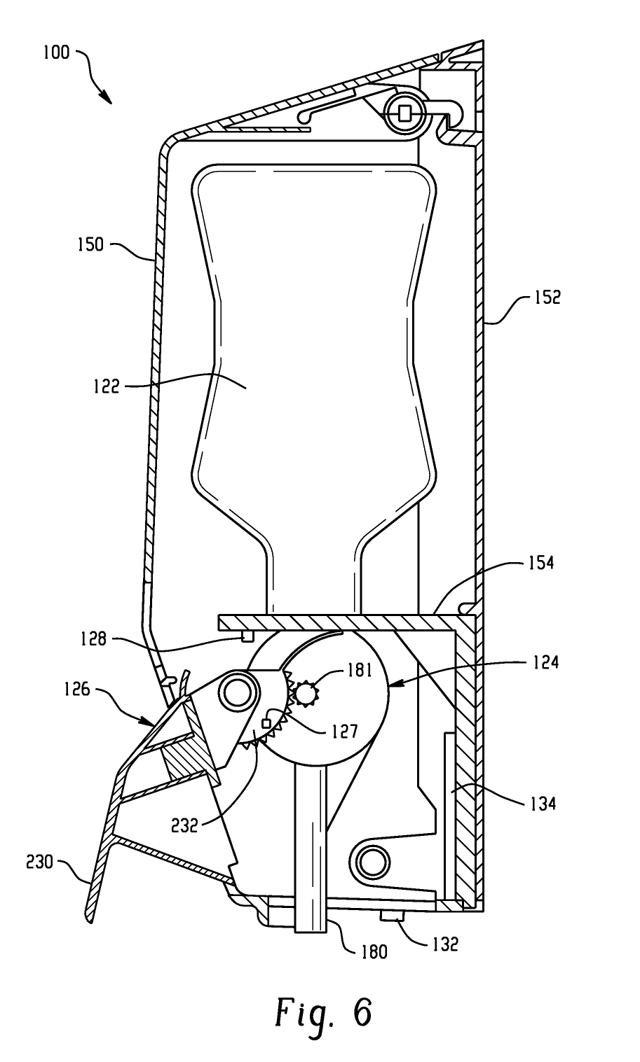

Referring to FIGS. 5 and 6, a manual dispenser 100 for dispensing a flowable product is illustrated. The manual dispenser 100 includes a housing 120, a container 122, a rotary pumping unit 124, a drive assembly 126, a position sensor 128, a magnet 127, an ultraviolet light source 132, and a controller 134. The flowable product comprises any product that can flow out of a dispenser. For example, the flowable product can comprise at least one of: (i) a soap, (ii) an antibacterial substance or lotion, (iii) a powder, (iv) a liquid, (v) a foam, (vi) a gel, (vii) a lotion and (viii) a detergent. An advantage of the manual dispenser 100 is that the manual dispenser 100 can emit an ultraviolet light to kill bacteria on a person's hands in addition to dispensing the flowable product.

The housing 120 is provided to enclose a portion of the remaining components of the manual dispenser 100. The housing 120 includes a front cover 150, a back cover 152, and an L-bracket 154. In one exemplary embodiment, the front cover 150, the back cover 152, and the L-bracket 154 are constructed from plastic. The front cover 150 is configured to be attached to the back cover 152 and the back cover 152 is configured to be mounted on a wall (not shown). The L-bracket 154 is coupled to the back cover 152 and is configured to hold the container 122 thereon.

The container 122 is provided to hold the flowable product therein. The container 122 can be constructed from plastic. The container 122 includes an opening for allowing the flowable product to be pumped from the container 122.

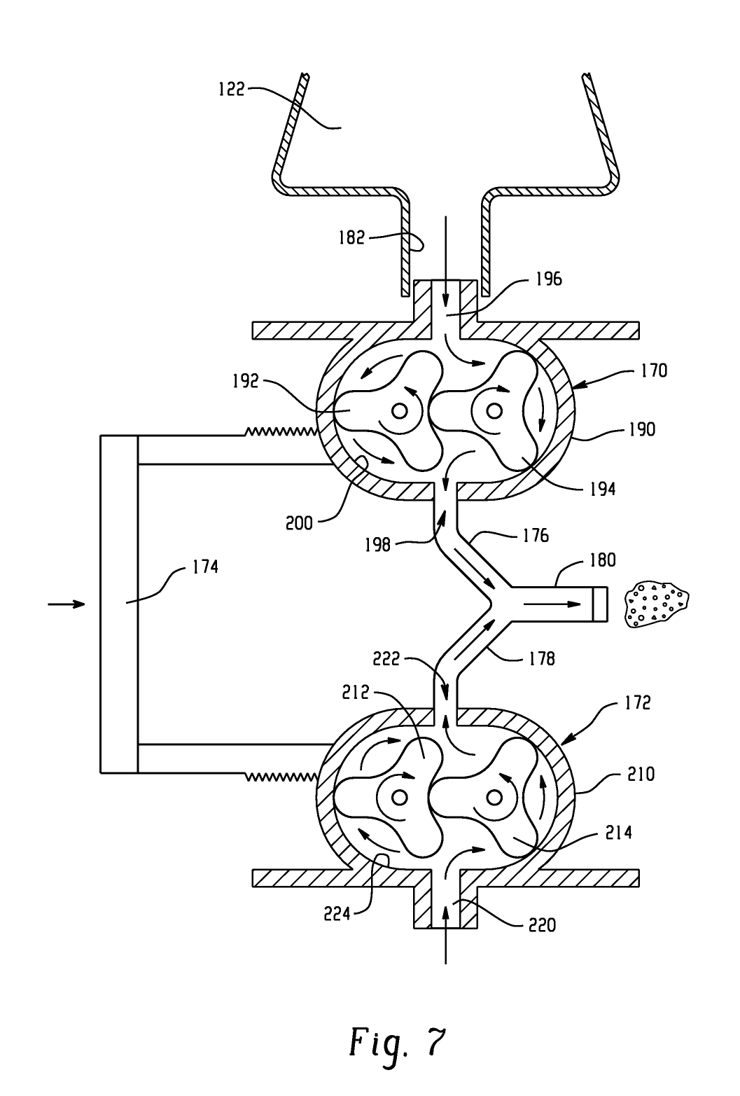

Referring to FIGS. 6 and 7, the rotary pumping unit 124 is provided to pump the flowable product from the container 122. The rotary pumping unit 124 includes a flowable product pump 170, an air pump 172, a drive bar 174, outlet tubes 176, 178, a mixing tube 180, and a gear 181.

The flowable product pump 170 is configured to pump the flowable product from the container 122 in response to movement from a push bar 230 of the drive assembly 126. The flowable product pump 170 includes a housing 190 and tri-lobes 192, 194 disposed in the housing 190. The housing 190 includes an inlet 196, an outlet 198, and a chamber 200. The inlet 196 fluidly communicates with an opening 182 of the container 122. The outlet 198 fluidly communicates with the outlet tube 176. The tri-lobes 192, 194 are disposed within the chamber 200. The drive bar 174 is operably coupled to the gear 181 disposed on an exterior of the rotary pumping unit 124. During operation, the drive assembly 126 rotates the gear 181 which causes linear movement of the drive bar 174. Linear movement of the drive bar 174 rotates the tri-lobes 192, 194 in opposite rotational directions. Further, rotation of the tri-lobes 192, 194 pumps flowable product from the container 122 through the chamber 200 to the outlet tube 176.

The air pump 172 is configured to pump ambient air into the outlet tube 178 in response to movement from the push bar 230 of the drive assembly 126. The air pump 172 includes a housing 210 and tri-lobes 212, 214 disposed in the housing 210. The housing 210 includes an inlet 220, an outlet 222, and a chamber 224. The inlet 220 fluidly communicates with ambient air. The outlet 222 fluidly communicates with the outlet tube 178. The tri-lobes 212, 214 are disposed within the chamber 224. During operation, the drive assembly 126 rotates the gear 181 which causes linear movement of the drive bar 174. Linear movement of the drive bar 174 rotates the tri-lobes 212, 214 in opposite rotational directions. Further, rotation of the tri-lobes 212, 214 pumps flowable product from the container 122 through the chamber 224 to the outlet tube 178.

As discussed above, during operation the flowable product pump 170 pumps flowable product to the outlet tube 176 and the air pump 172 pumps air into the outlet tube 178. The outlet tubes 176, 178 are fluidly coupled to the mixing tube 180. Thus, the mixture of flowable product and air mix together in the mixing tube 180 and are pumped out of the mixing tube 180 onto a person's hands.

Referring to FIG. 6, the drive assembly 126 is provided to allow a person to actuate the rotary pumping unit 124. The drive assembly 126 includes the push bar 230 and a drive rack 232 coupled to the push bar 230. The drive rack 232 is operably coupled to the gear 181. During operation, a person depresses the push bar 230 toward the back cover 152 from a first operational position to a second operational position which induces the drive rack 232 to rotate the gear 181 to actuate the rotary pumping unit 124.

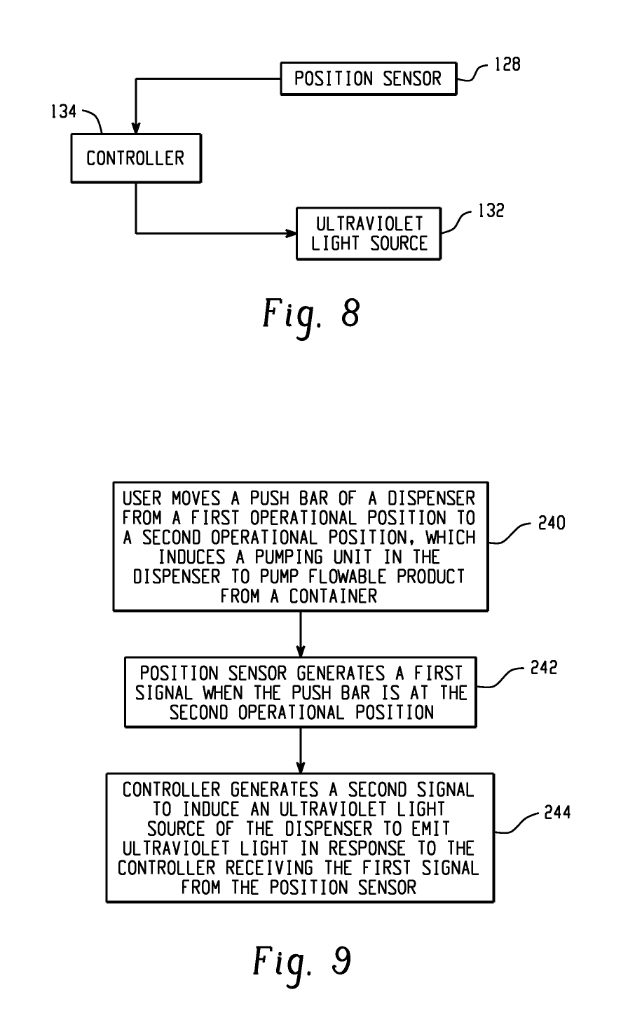

Referring to FIGS. 6 and 8, the position sensor 128 is configured to generate a signal when the magnet 127 is disposed proximate to the position sensor 128. The magnet 127 is disposed on the drive rack 232. When the push bar 230 is moved from a first operational position to a second operational position, the position sensor 128 detects the magnet 127 and generates a signal which is received by the controller 134. In one exemplary embodiment, the position sensor 128 is disposed on the L-bracket 154.

The ultraviolet light source 132 is configured to emit ultraviolet light in response to signal received from the controller 134. In one exemplary embodiment, the ultraviolet light source 132 is disposed on an external portion of the housing 120 proximate to the mixing tube 180. Further, in one exemplary embodiment, the ultraviolet light is in either the B-band (i.e., 320 nm-280 nm wavelength with energy per photon of 3.10-3.87 eV) or C-band (i.e., below 280 nm wavelength with energy per photon of 4.43-6.20 eV) of an ultraviolet light spectrum. In another exemplary embodiment, the ultraviolet light has a wavelength of 253.7 nm with a radiation level of 3.0 Joules/m².

The controller 134 is provided to control operation of the ultraviolet light source 132. The controller 134 is electrically coupled to the position sensor 128 and the ultraviolet light source 132. The controller 134 is configured to receive a signal from the position sensor 128 indicating the push bar 230 has been depressed. The controller 134 is further configured to generate another signal to induce the ultraviolet light source 132 to emit ultraviolet light onto a person's hands to kill bacteria thereon.

Referring to FIG. 9 (with periodic reference to FIG. 6), a flowchart of a method for controlling the manual dispenser 100 in accordance with another exemplary embodiment will now be explained.

At block 240, a user moves the push bar 230 of the manual dispenser 100 from a first operational position to a second operational position, which induces the rotary pumping unit 124 in the manual dispenser 100 to pump flowable product from the container 122.

At block 242, the position sensor 128 generates a first signal when the push bar 230 is at the second operational position.

At block 244, the controller 134 generates a second signal to induce the ultraviolet light source 132 of the manual dispenser 100 to emit ultraviolet light in response to the controller 134 receiving the first signal from the position sensor 128.

The dispensers for dispensing a flowable product and the methods associated therewith provide a substantial advantage over other dispensers and methods. In particular, the dispenser and methods provide a technical effect of emitting an ultraviolet light to kill bacteria on a person's hand.

While the invention has been described with reference to exemplary embodiments, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying this invention, but that the invention will include all embodiments falling within the scope of the appended claims. Moreover, the use of the terms, first, second, etc. are used to distinguish one element from another. Furthermore, the use of the terms a, an, etc. do not denote a limitation of quantity, but rather denote the presence of at least one of the referenced items.

What is claimed is:

1. A dispenser for dispensing a flowable product, comprising:
a housing;
a container disposed in the housing, the container holding the flowable product therein;
a pumping unit disposed in the housing, the pumping unit fluidly communicating with the container, the pumping unit configured to pump the flowable product from the container; and
an ultraviolet light source disposed on the housing, the ultraviolet light source configured to emit ultraviolet light.

2. The dispenser of claim 1, further comprising:
a sensor disposed on the housing, the sensor configured to generate a first signal; and
a controller operably coupled to the sensor and the ultraviolet light source, the controller configured to generate a second signal to induce the ultraviolet light source to emit the ultraviolet light in response to receiving the first signal from the sensor.

3. The dispenser of claim 2, wherein the sensor comprises a proximity sensor configured to generate the first signal when an object is disposed proximate to the proximity sensor.

4. The dispenser of claim 3, further comprising a motor operably coupled to the pumping unit, the motor configured to actuate the pumping unit to pump the flowable product from the container in response to a third signal, the controller further configured to generate the third signal in response to the controller receiving the first signal from the proximity sensor.

5. The dispenser of claim 4, wherein in response to the controller receiving the first signal, the controller is configured to generate the third signal before the second signal, thereby inducing the ultraviolet light source to emit ultraviolet light after initiating pumping of the flowable product.

6. The dispenser of claim 2, wherein the pumping unit has a push bar, the push bar having first and second operational positions, the pumping unit being actuated to pump the flowable product from the container when the push bar is moved from the first operational position to the second operational position, the sensor comprising a position sensor configured to generate the first signal indicative of an operational position of the push bar, the controller configured to generate the second signal to induce the ultraviolet light source to emit ultraviolet light in response to receiving the first signal from the position sensor, when the first signal indicates the push bar is at the second operational position.

7. The dispenser of claim 1, wherein the ultraviolet light emitted from the ultraviolet light source is in a B-band of an ultraviolet light spectrum.

8. The dispenser of claim 1, wherein the ultraviolet light emitted from the ultraviolet light source is in a C-band of an ultraviolet light spectrum.

9. A method for controlling a dispenser for dispensing a flowable product, the dispenser having a sensor, a container holding the flowable product therein, a pumping unit fluidly communicating with the container, an ultraviolet light source, and a controller, the method comprising:
generating a first signal utilizing the sensor of the dispenser; and
generating a second signal to induce the ultraviolet light source of the dispenser to emit ultraviolet light in response to the controller of the dispenser receiving the first signal from the sensor.

10. The method of claim 9, wherein the sensor comprises a proximity sensor, and generating the first signal comprises generating the first signal utilizing the proximity sensor when an object is disposed proximate to the proximity sensor.

11. The method of claim 10, wherein the dispenser further comprises a motor operably coupled to the pumping unit, the method further comprising:
generating a third signal utilizing the controller in response to the controller receiving the first signal from the proximity sensor; and
actuating the pumping unit utilizing the motor to pump the flowable product from the container, in response to the motor receiving the third signal.

12. The method of claim 10, wherein the pumping unit further comprises a push bar, the push bar having first and second operational positions, the sensor comprising a position sensor configured to generate the first signal indicative of an operational position of the push bar, wherein generating the second signal comprises:
generating the second signal to induce the ultraviolet light source to emit ultraviolet light in response to receiving the first signal from the position sensor, when the first signal indicates the push bar is at the second operational position.

13. The method of claim 9, wherein the ultraviolet light emitted from the ultraviolet light source is in a B-band of an ultraviolet light spectrum.

14. The method of claim 9, wherein the ultraviolet light emitted from the ultraviolet light source is in a C-band of an ultraviolet light spectrum.
